(19) United States
(12) Patent Application Publication
(10) Pub. No.: US 2006/0249396 A1
(43) Pub. Date: Nov. 9, 2006

(54) Method for determining the position of an electrochemically machined channel

(76) Inventors: Rene Jabado, Berlin (DE); Ursus Kruger, Berlin (DE); Daniel Kortvelyessy, Berlin (DE); Ralph Reiche, Berlin (DE); Michael Rindler, Schoneiche (DE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/364,735

(22) Filed: Feb. 28, 2006

(30) Foreign Application Priority Data
Feb. 28, 2005 (EP) 05004365.2

(51) Int. Cl. B23H 3/02

(52) U.S. Cl. 205/641

(57) ABSTRACT

The invention provides a method for determining the position of a channel which has been electrochemically machined in a workpiece by an electrolyte and/or the wall thickness which is present between the electrochemically machined channel and the surface of the component, in which magnetic particles are added to the electrolyte used during the machining, the magnetic fields associated with the magnetic particles are detected, and the position of the electrochemically machined channel and/or the wall thickness which is present between the electrochemically machined channel and the surface of the component is determined on the basis of the detected magnetic fields.

### CROSS REFERENCE TO RELATED APPLICATIONS

This application claims the benefits of European Patent application No. 05004365.2 EP filed Feb. 28, 2005. All of the applications are incorporated by reference herein in their entirety.

### FIELD OF THE INVENTION

The present invention relates to a method for determining the position of an electrochemically machined channel in a workpiece and to a method for monitoring an electrochemical machining process.

### BACKGROUND OF THE INVENTION

Large numbers of electrochemical machining processes are used to drill holes and channels with small diameters in metal. Channels of this type are difficult to drill mechanically. During electrochemical machining, a nozzle delivers an electrolyte into the drilled hole, and this electrolyte electrically conductively connects the nozzle to the material of the workpiece. An electric current flowing through the electrolyte leads to material being removed from the workpiece, and this material is then carried away by the flowing electrolyte. During electrochemical machining, the nozzle generally represents the cathode and the workpiece the anode.

Electrochemical machining processes are used in the production of gas turbine components, for example to drill cooling air holes, for example in turbine blades and vanes. The drilling of the cooling air holes even in the production of new components is a highly critical process which leads to exceptionally high scrap rates. In particular the drilling of cooling air channels in turbine blades or vanes along the blade or vane axis causes problems. If an inhomogeneity in the base material, for example a grain of different material composition, is encountered during the drilling process, this grain can lead to the nozzle deviating from the predetermined path through the material. During this deviation, the nozzle can under certain circumstances come unacceptably close to the outer contour of the component.

Hitherto, there has been no known method for determining the position of the drilled channel in the workpiece or the wall thickness which is present between the channel and the surface of the workpiece during the electrochemical machining process.

### SUMMARY OF THE INVENTION

Therefore, it is an object of the present invention to provide a method which makes it possible to determine the position of the drilled channel in a workpiece and/or the wall thickness which is present between the channel and the surface of the workpiece while the machining operation is still ongoing. A further object of the present invention is to provide a method for monitoring an electrochemical machining process which makes it possible to react to deviations in the drilled channel from an ideal machining line or to deviations in the wall thickness between the channel and the surface of the workpiece from a predetermined wall thickness while the machining operation is still in progress.

The first object is achieved by the method as claimed in the claims for determining the position of a channel which has been electrochemically machined in a workpiece by means of an electrolyte and/or the wall thickness which is present between an electrochemically machined channel and the surface of the workpiece, and the second object is achieved by the method as claimed in the claims for monitoring an electrochemical machining process.

In the method according to the invention for determining the position of a channel which has been electrochemically machined in a workpiece by means of an electrolyte and/or the wall thickness which is present between an electrochemically machined channel and the surface of the workpiece, magnetic particles are added to the electrolyte used during the machining. The magnetic fields associated with the magnetic particles are detected, and the position of the electrochemically machined channel and/or the wall thickness which is present between an electrochemically machined channel and the surface of the workpiece is determined from the detected magnetic fields. The recording of the wall thickness in this context offers the advantage that only a one-dimensional variable needs to be recorded.

Since the detection of the magnetic fields can be carried out as early as during the machining process, the method according to the invention allows the position of the machined channel and/or the wall thickness which is present between an electrochemically machined channel and the surface of the workpiece to be determined as early as during the machining process. In particular, the position of the channel or the wall thickness in the region of the nozzle used to supply the magnetic particles can be determined. The wall thickness can be worked out either directly from the detected magnetic fields or from the position of the channel in combination with the known position of the surface of the workpiece.

In particular a superconducting quantum interference detector, known as a SQUID, can be used to detect the magnetic fields. The high sensitivity of these SQUIDs leads to a good resolution in the determination of the position of the magnetic particles and therefore in the determination of the position of the drilled channel. It is in this way possible to determine the position with a lateral resolution of 0.1 mm or better.

The position of the electrochemically machined channel can be determined in particular with the aid of a SQUID microscope, in which the superconducting quantum interference detector is used to detect the magnetic fields.

The method according to the invention for determining the position of a channel which has been electrochemically machined in a workpiece by means of an electrolyte and/or the wall thickness which is present between the electrochemically machined channel and the surface of the workpiece is used in the method according to the invention for monitoring an electrochemical machining process. This allows on-line monitoring of the position of the electrochemical drill, i.e. the nozzle of the drill, and/or of the wall thickness between the drill and the surface of the workpiece during the machining process. Deviations from a predetermined machining line, or the wall thickness dropping below a predetermined wall thickness, can in this way be detected, for example on the basis of a comparison between the detected machining line and the predetermined machining line or a comparison between the detected wall thickness and the predetermined wall thickness as early as during the machining operation.

If a deviation in the machined channel from the predetermined machining line which is more than a predetermined permissible deviation is detected, or if it is detected that the wall thickness has dropped below the predetermined wall thickness, it is possible, in a refinement of the monitoring method, to terminate the electrochemical machining. There is then no need to invest any further unnecessary machining time in a workpiece which will subsequently be scrapped.

Alternatively, it is also possible for the workpiece to be held under mechanical stress during the machining and to alter the mechanical stress if a comparison of the determined position of the machined channel with the predetermined machining line ascertains that a predetermined permissible deviation has been exceeded or if a comparison of the detected wall thickness with the predetermined wall thickness ascertains that the wall thickness has dropped below a predetermined wall thickness. The direction in which the machining process continues can be influenced by changing the stress, and it is in this way possible, for example, to prevent the distance between the machined channel and the component surface from dropping below the predetermined minimum. The permissible deviation in the position of the machined channel from the ideal machining line should in this case be selected to be sufficiently small for the deviation not to force the workpiece to be considered scrap. The machining operation can if appropriate be interrupted in order to alter the mechanical stress.

As a further alternative, it is possible to continuously record the position of the electrochemically machined channel in the workpiece or the wall thickness which is present between the electrochemically machined channel and the surface of the workpiece and to feed this information to a control unit, which, on the basis of the comparison of the recorded position of the electrochemically machined channel in the workpiece with the predetermined machining line or of the comparison of the recorded wall thickness with the predetermined wall thickness, outputs a control variable for influencing the mechanical stress.

### BRIEF DESCRIPTION OF THE DRAWINGS

Further features, properties and advantages of the present invention will emerge from the following description of an exemplary embodiment with reference to the appended figures, in which:

FIG. 1 shows a highly diagrammatic illustration of the way in which the method according to the invention for determining the position of a channel which has been electrochemically machined in a workpiece by means of an electrolyte is carried out.

FIG. 2 shows an example of a gas turbine in the form of a partial longitudinal section.

FIG. 3 shows a perspective view of a rotor blade or guide vane of a turbomachine.

FIG. 4 shows a combustion chamber of a gas turbine.

### DETAILED DESCRIPTION OF THE INVENTION

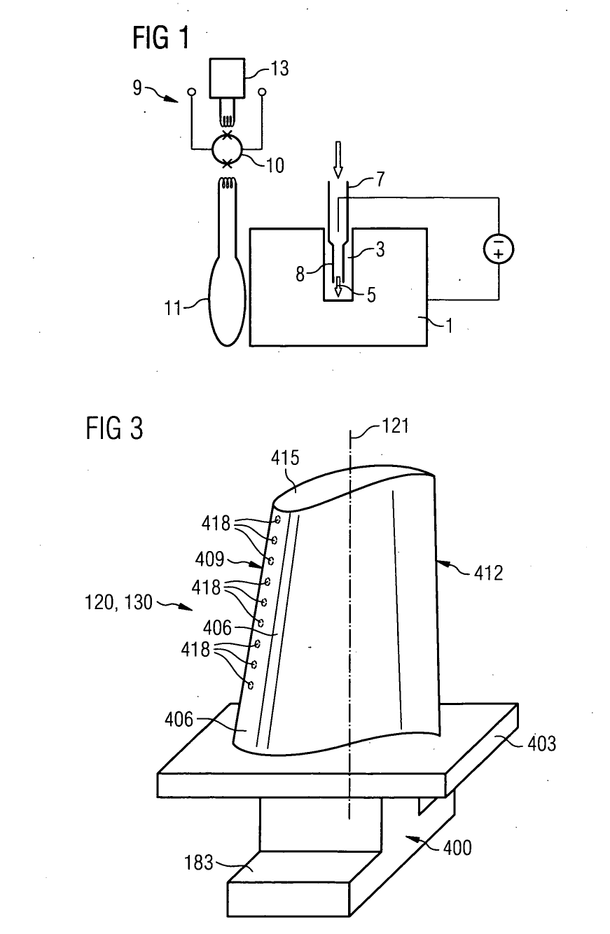

FIG. 1 shows a workpiece 1 into which a channel 3 is being electrochemically machined. The machining is carried out by means of an electrolyte 5 which passes out of a nozzle 8 arranged at the tip of a machining tool 7 into the channel 3. The actual machining operation is carried out by oxidation of the material of the workpiece 1 with the aid of the electrolyte 5. The electrolyte 5 is supplied from a reservoir (not shown in FIG. 1).

To enable an oxidation of the metallic base material of the workpiece 1 to take place, a negative voltage is applied to the machining tool 7, in particular to the nozzle 8, so that the nozzle 8 acts as a cathode. By contrast, a positive voltage is applied to the workpiece 1, so that it acts as an anode. With the voltage applied, the electrolyte 5 dissolves the metallic material of the workpiece 1 by oxidation. The dissolved material can then be removed from the machined channel together with the electrolyte. The electrolyte together with the dissolved base material is generally flushed out of the machined channel 3 by electrolyte which continues to flow in through the nozzle. During the machining process, the nozzle 8 is continuously advanced in the machined channel.

In the method according to the invention, magnetic particles are admixed with the electrolyte. The magnetic fields of these particles can be detected by means of suitable detectors. The position of the magnetic particles and therefore the profile of the machined channel can then be determined from the signals detected by the detector.

It is also possible to add magnetizable particles which have been previously magnetized, for example by the recording coil 11. Furthermore, it is possible to apply an external magnetic field, in which case the particles influence the magnetic field, so as to generate feedback from which the desired data can be determined (eddy current testing).

In the present exemplary embodiment, a SQUID 10, which is part of a SQUID microscope 9 that is only diagrammatically depicted in the figure, is used to detect the magnetic fields. A SQUID is a highly sensitive detector for magnetic fields. It substantially comprises a superconducting loop which is interrupted by at least one Josephson element, as it is known. Josephson elements of this type are generally either constrictions in the superconducting loop or thin insulators which isolate adjacent regions of the superconducting loop from one another. In the circuit diagram for the SQUID 10, the Josephson elements are indicated by crosses and the superconducting loop by a circle.

To detect the magnetic fields, the SQUID 10 can be biased with a DC voltage.

In a SQUID microscope 9, the magnetic field to be detected is generally recorded with the aid of a recording coil 11, which is inductively coupled to the SQUID 10. Moreover, the SQUID 10 is likewise inductively coupled to an evaluation circuit 13 of the microscope 9. At this point, it should be pointed out that the recording coil 11 is not illustrated to scale. The aim is typically to minimize the size of the recording coil 11.

The SQUID microscope 9 is used to determine the position of the magnetic particles in the machined channel and in particular in the region of the nozzle 8. On account of the high sensitivity of a SQUID 10, it is possible to determine the position of the particles with a lateral accuracy of 0.1 mm or better. In this way, the position of the machined channel as it advances can be monitored while the machining process is still ongoing, and it is if appropriate possible to intervene if the position deviates from a predetermined machining line.

Instead of the (three-dimensional) position of the channel 3, it is alternatively or additionally possible to determine the wall thickness which remains between the channel 3 and the surface of the workpiece 1. By way of example, a comparison of the position of the channel with the position of the wall can be used to determine the wall thickness. However, it is also possible for the wall thickness to be determined directly from the magnetic fields detected by the SQUID 10, so that only a one-dimensional variable has to be determined.

In the monitoring method according to the invention, the determination of the position of the machined channel or the wall thickness is used to monitor the machining process.

In a first alternative of the monitoring method, a defined maximum permissible deviation from the ideal machining line or a minimum wall thickness which the wall thickness must not drop below is predetermined. If the maximum permissible deviation from the ideal machining line is exceeded or if the wall thickness drops below the minimum wall thickness, the machining operation is terminated.

In a second variant of the monitoring method according to the invention, the workpiece 1 is under mechanical stress during the electrochemical machining. The profile of the machined channel 3 in the workpiece 1 can be influenced by varying the mechanical stress. If the maximum permissible deviation in the position of the channel 3 from the ideal machining line is then selected to be so low that the deviation does not yet mean that the workpiece has to be regarded as scrap, it is possible to have a correcting influence on the further profile of the machined channel 3 by altering the mechanical stress. When the maximum permissible deviation is reached or when the wall thickness drops below the minimum wall thickness, the machining process is interrupted and the mechanical stress is corrected. After the mechanical stress has been corrected, the machining process can then be continued. It is in this way possible to increase the yield during electrochemical machining.

As a third alternative, it is also possible to provide a control unit which compares the recorded wall thickness with a predetermined desired wall thickness which is to be maintained and, on the basis of the comparison, outputs a control variable used to set the mechanical stress in such a manner as to maintain the desired wall thickness. Instead of determining the control variable on the basis of the recorded wall thickness and the comparison between the recorded wall thickness and the desired wall thickness, it is also possible to determine the control variable on the basis of the recorded position of the channel 3 and a comparison of the recorded position with a predetermined machining line.

The methods described can be used in particular for machining cooling air channels in turbine components, in particular in gas turbine blades or vanes. Therefore, the text which follows describes a gas turbine installation in which components having electrochemically machined cooling air holes are used. The machining of the cooling air holes or film-cooling holes described therein can be monitored using the method according to the invention in particular.

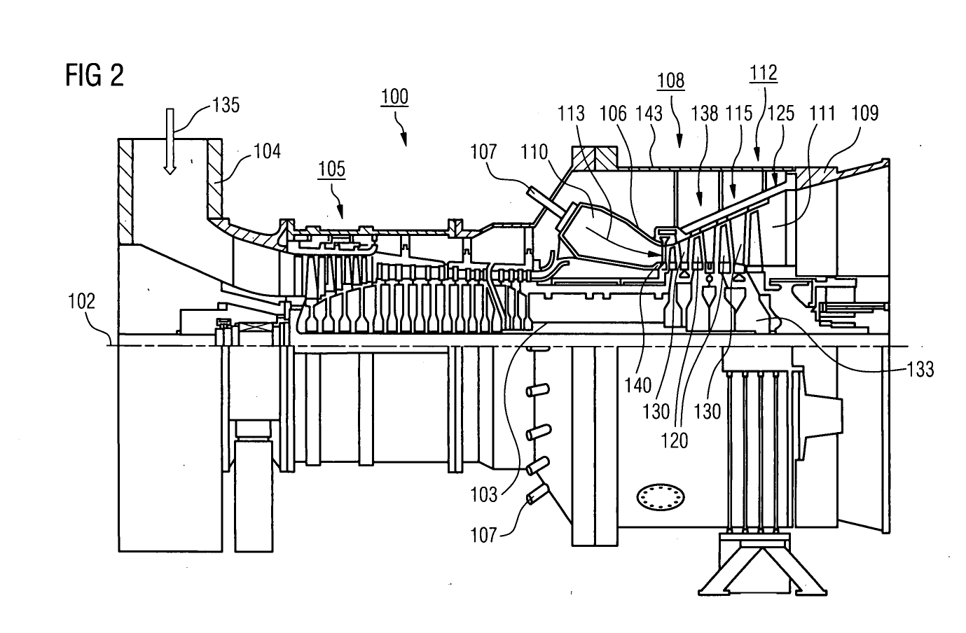

FIG. 2 shows, by way of example, a partial longitudinal section through a gas turbine 100. In the interior, the gas turbine 100 has a rotor 103 which is mounted such that it can rotate about an axis of rotation 102 and is also referred to as the turbine rotor. An intake housing 104, a compressor 105, a, for example, toroidal combustion chamber 110, in particular an annular combustion chamber 106, with a plurality of coaxially arranged burners 107, a turbine 108 and the exhaust-gas housing 109 follow one another along the rotor 103.

The annular combustion chamber 106 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield bricks which line the annular combustion chamber 106, are subject to the highest thermal stresses.

To be able to withstand the temperatures which prevail there, they can be cooled by means of a coolant.

Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110. Superalloys of this type are known, for example, from EP 1 204 776 B1, EP 1 306 454, EP 1 319 729 A1, WO 99/67435 or WO 00/44949; these documents form part of the disclosure.

The blades or vanes 120, 130 may also have coatings which protect against corrosion (MCrAlX; M is at least one element selected from the group consisting of iron (Fe), cobalt (Co), nickel (Ni), X is an active element and represents yttrium (Y) and/or silicon and/or at least one rare earth element or hafnium). Alloys of this type are known from EP 0 486 489 B1, EP 0 786 017 B1, EP 0 412 397 B1 or EP 1 306 454 A1, which are intended to form part of the present disclosure.

A thermal barrier coating, consisting for example of ZrO₂, Y₂O₄—ZrO₂, i.e. unstabilized, partially stabilized or completely stabilized by yttrium oxide and/or calcium oxide and/or magnesium oxide, may also be present on the MCrAlX. Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 3 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406. As a guide vane 130, the vane 130 may have a further platform (not shown) at its vane tip 415.

A blade or vane root 183, which is used to secure the rotor blades 120, 130 to a shaft or a disk (not shown), is formed in the securing region 400. The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130. Superalloys of this type are known, for example, from EP 1 204 776 B1, EP 1 306 454, EP 1 319 729 A1, WO 99/67435 or WO 00/44949; these documents form part of the disclosure. The blade or vane 120, 130 may in this case be produced by a casting process, also by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally. In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures). Processes of this type are known from U.S. Pat. No. 6,024,792 and EP 0 892 090 A1; these documents form part of the disclosure.

The blades or vanes 120, 130 may likewise have coatings protecting against corrosion or oxidation (MCrAlX; M is at least one element selected from the group consisting of iron (Fe), cobalt (Co), nickel (Ni), X is an active element and represents yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of the present disclosure.

It is also possible for a thermal barrier coating, consisting for example of ZrO₂, Y₂O₄—ZrO₂, i.e. unstabilized, partially stabilized or completely stabilized by yttrium oxide and/or calcium oxide and/or magnesium oxide, to be present on the MCrAlX. Columnar grains are produced in the thermal barrier coating by means of suitable coating processes, such as for example electron beam physical vapor deposition (EB-PVD).

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled; it is hollow and may also have film-cooling holes 418 (indicated by dashed lines).

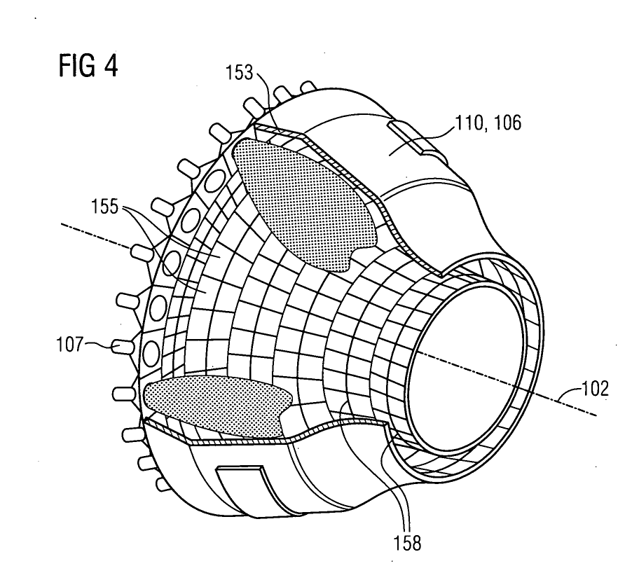

FIG. 4 shows a combustion chamber 110 of a gas turbine. The combustion chamber 110 is configured, for example, as what is known as an annular combustion chamber, in which a multiplicity of burners 107 arranged circumferentially around the axis of rotation 102 open out into a common combustion chamber space. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 is equipped with a particularly heat-resistant protective layer or is made from material that is able to withstand high temperatures. These may be solid ceramic bricks or alloys with MCrAlX and/or ceramic coatings. The materials of the combustion chamber wall and their coatings may be similar to the turbine blades or vanes.

A cooling system may also be provided for the heat shield elements 155 and/or their holding elements, on account of the high temperatures in the interior of the combustion chamber 110.

The combustion chamber 110 is designed in particular to detect losses from the heat shield elements 155. For this purpose, a number of temperature sensors 158 are positioned between the combustion chamber wall 153 and the heat shield elements 155.

1-9. (canceled)

10. A method for determining the position of an electrochemically machined channel of a turbine component, comprising:
adding magnetic or magnetizable particles to an electrolyte used in the machining of the channel;
detecting a plurality of magnetic fields associated with the particles; and
determining the position of the electrochemically machined channel based on the detected magnetic fields.

11. The method as claimed in claim 10, wherein the magnetic fields are generated by the particles.

12. The method as claimed in claim 10, wherein a superconducting quantum interference detector is used to detect the magnetic fields.

13. The method as claimed in claim 10, wherein the position of the electrochemically machined channel is determined by an angle of the channel, a thickness of a wall or a distance between the channel and an adjacent channel.

14. The method as claimed in claim 11, wherein the superconducting quantum interference detector is part of a SQUID microscope used to detect the magnetic fields.

15. A method for determining the position of an electrochemically machined channel of a turbine component, comprising:
adding magnetic or magnetizable particles to an electrolyte used in the machining of the channel;
detecting a plurality of magnetic fields generated by the particles via a superconducting quantum interference detector; and
determining a wall thickness between the electrochemically machined channel and a surface of the workpiece based on the detected magnetic fields.

16. The method as claimed in claim 15, wherein the superconducting quantum interference detector is part of a SQUID microscope used to detect the magnetic fields.

17. A method for monitoring an electrochemical machining process, comprising:
adding magnetic or magnetizable particles to an electrolyte used in the machining process;
detecting a magnetic field associated with the particles;
determining a position of an electrochemically machined channel based on the detected magnetic fields; and
comparing the position of the electrochemically machined channel with a predetermined machining path during the machining process.

18. The method as claimed in claim 17, further comprising terminating the machining if a permissible deviation in the position of the electrochemically machined channel from the predetermined machining path has been exceeded.

19. The method as claimed in claim 17, wherein the wall thickness which remains between the channel and the surface of the workpiece is compared with a predetermined wall thickness during the monitoring of the electrochemical machining process.

20. The method as claimed in claim 19, further comprising terminating the machining if the wall thickness is less than the predetermined wall thickness.

21. The method as claimed in claim 17, wherein the workpiece is mechanically stressed during the machining process and the mechanical stress is adjusted if the deviation between the machined channel position and the predetermined machining path has been exceeded.

22. The method as claimed in claim 21, wherein the position of the electrochemically machined channel in the workpiece is continuously provided to a control unit.

23. The method as claimed in claim 22, wherein the control unit output influences the mechanical stress based on the comparison of the recorded position of the electrochemically machined channel in the workpiece with the predetermined machining line.

24. The method as claimed in claim 17, wherein the workpiece is mechanically stressed during the machining process and the mechanical stress is adjusted if the wall thickness becomes less than a predetermined minimum value.

25. The method as claimed in claim 24, wherein the wall thickness between the electrochemically machined channel and the surface of the workpiece is continuously provided to a control unit.

26. The method as claimed in claim 25, wherein the control unit output influences the mechanical stress based on the comparison of the recorded wall thickness with the predetermined wall thickness.
